(19) United States
(12) Patent Application Publication
(10) Pub. No.: US 2026/0365143 A1
(43) Pub. Date: Nov. 19, 2026

(54) VEHICULAR VISION SYSTEM WITH LENS OCCLUSION DETECTION AND LENS CLEANING

(71) Applicant: Magna Electronics Inc., Auburn Hills, MI (US)

(72) Inventors: Nanubala Guru Siva Prasad, Karnataka (IN); Ramallingeswara Rao P, Andhra Pradesh (IN)

(21) Appl. No.: 19/670,318

(22) Filed: May 7, 2026

Related U.S. Application Data
(60) Provisional application No. 63/806,788, filed on May 16, 2025.

(51) Int. Cl. B60S 1/56; B60R 1/22; B60S 1/08; B60S 1/48; B60S 1/52; B60S 1/54; G02B 27/00; H04N 23/81

(52) U.S. Cl. CPC B60S 1/56; B60R 1/22; B60S 1/0818; B60S 1/485; B60S 1/52; B60S 1/54; G02B 27/0006; H04N 23/811

(57) ABSTRACT

A vehicular vision system includes a camera and an electronic control unit (ECU) that determines, responsive to processing by an image processor of the image data captured by the camera, that the field of view of the camera is occluded. The vehicular vision system determines a type of occlusion based at least in part on a current environmental condition. The vehicular vision system selects a physical camera cleaning system from a plurality of physical camera cleaning systems based on the determined type of occlusion. The vehicular vision system displays a notification to a driver of the vehicle indicating that the camera is occluded. The vehicular vision system enables the selected physical camera cleaning system.

### CROSS REFERENCE TO RELATED APPLICATION

The present application claims the filing benefits of U.S. provisional application Ser. No. 63/806,788, filed May 16, 2025, which is hereby incorporated herein by reference in its entirety.

### TECHNICAL FIELD

The present disclosure relates generally to a vehicle vision system for a vehicle and, more particularly, to a vehicle vision system that utilizes one or more cameras at a vehicle.

### BACKGROUND

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY

A vehicular vision system includes a camera disposed at a vehicle equipped with the vehicular vision system and viewing exterior of the vehicle. The camera captures image data. The camera includes an imager. The system includes an electronic control unit (ECU) with electronic circuitry and associated software. The electronic circuitry of the ECU includes an image processor for processing image data captured by the camera to detect presence of objects in a field of view of the camera. The ECU determines, responsive to processing by the image processor of the image data captured by the camera, that the field of view of the camera is occluded. The vehicular vision system determines a type of occlusion based at least in part on a current environmental condition. The vehicular vision system selects a physical camera cleaning system from a plurality of physical camera cleaning systems based on the determined type of occlusion, and each physical camera cleaning system of the plurality of physical camera cleaning systems is configured to physically remove the occlusion from a lens or a transparent cover of the camera. The vehicular vision system displays a notification to a driver of the vehicle indicating that the camera is occluded. The vehicular vision system enables the selected physical camera cleaning system.

These and other objects, advantages, purposes and features of the present disclosure will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a perspective view of a vehicle and an overlaid and zoomed-in front view of a front camera module;

FIG. 3 is a plan view of a vehicle with a vision system that incorporates cameras; and

FIG. 4 is a block diagram of dirty lens detection for a vehicular vision system.

### DETAILED DESCRIPTION

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like. The captured image data may comprise video feeds having a sequence of image frames captured at a predefined frame rate, and the image processor may utilize various machine vision algorithms, edge detection techniques, and/or deep learning models, such as convolutional neural networks (CNNs), to perform object detection, classification, and tracking. The detected objects may include, by way of example, pedestrians, cyclists, other vehicles, lane markers, traffic signs, debris, and infrastructure elements. The display device may comprise a liquid crystal display (LCD), a light emitting diode (LED) display, an organic light emitting diode (OLED) display, a head-up display (HUD), or the like, configured to provide real-time or near real-time visual feedback to the driver.

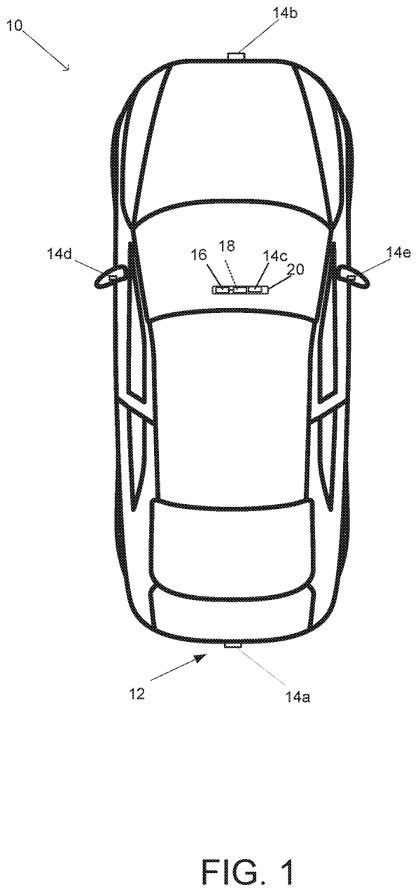

Referring now to the drawings and the illustrative implementations depicted therein, a vehicle 10 includes an imaging system or vision system 12 that includes at least one exterior-viewing imaging sensor or camera, such as a rear backup camera or rearward-viewing imaging sensor or camera 14a (and the system may optionally include multiple exterior-viewing imaging sensors or cameras, such as a forward-viewing camera 14b at the front of the vehicle, a front camera module (FCM) 14c disposed behind a front windshield of the vehicle (viewing forward through the windshield), and a sideward/rearward-viewing camera 14d, 14e at respective sides of the vehicle), which captures images exterior of the vehicle, with the camera having a lens for focusing images at or onto an imaging array or imaging plane or imager of the camera (FIG. 1). Optionally, a forward-viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like).

The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle).

The data transfer or signal communication from the camera to the ECU may comprise any suitable data or communication link, such as a vehicle network bus or the like of the equipped vehicle. The imager of the camera may comprise a complementary metal-oxide-semiconductor (CMOS) imaging array having a plurality of photosensors arranged in rows and columns, such as an array of at least one million photosensors (e.g., a 1-megapixel array) or more. The lenses of the respective cameras 14a, 14b, 14d, 14e may comprise wide-angle lenses or fisheye lenses configured to capture a wide field of view (FOV), such as a FOV of 120 degrees to 190 degrees or more. The ECU 18 may comprise application-specific integrated circuits (ASICs), field-programmable gate arrays (FPGAs), systems-on-chip (SoCs), neural network accelerators, and/or volatile or non-volatile memory. The data transfer or signal communication may utilize high-speed automotive communication protocols, such as Low-Voltage Differential Signaling (LVDS), Automotive Ethernet, Controller Area Network Flexible Data-Rate (CAN-FD), or Gigabit Multimedia Serial Link (GMSL) protocols, to ensure low-latency transmission of high-resolution image data.

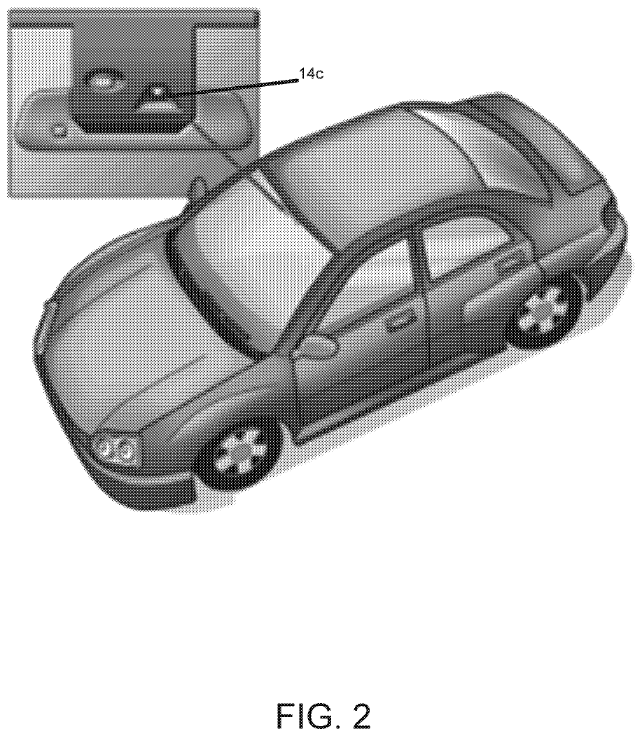

Advanced driving assist systems (ADASs) and/or vehicular vision systems have become a common feature of vehicles. An ADAS often includes an FCM (FIG. 2) that supports lane detection warning systems and/or lane-keep assist systems as well as object detection features of a vehicle. Accordingly, FCMs play a key role in modern vehicle safety systems and features. As discussed above, the FCM is often disposed behind a front windshield of the vehicle (e.g., mounted at an in-cabin side of the vehicle windshield), viewing forward through the windshield so as to capture image data representative of the scene occurring forward of the vehicle. For example, the FCM may view a road along which the vehicle is traveling.

The FCM may capture image data of the road for processing at the ECU, such that the ADAS may detect and/or determine lanes of the road and objects forward of the vehicle. The ADAS may, based on the captured image data, assist the driver by issuing warnings to the driver and/or controlling steering, braking, and/or acceleration of the vehicle. That is, the ADAS may assist the driver during unintended actions of the driver or in driving situations that otherwise require the ADAS to warn the driver or control steering, braking, and/or acceleration of the vehicle. The FCM 14c may comprise a monocular camera or a stereoscopic camera arrangement. Processing of the image data captured by the FCM 14c may be performed locally at an edge processor integrated directly within the housing of the FCM 14c, or centrally at the ECU 18.

By providing inputs to the vehicle's electronic power steering, electronic stability control, and/or drive-by-wire systems, the ADAS can implement advanced safety interventions such as autonomous emergency braking (AEB), adaptive cruise control (ACC), evasive steering assist, and automatic high-beam control. The FCM 14c is typically positioned to view through a region of the windshield that is actively wiped by the vehicle's windshield wipers; however, localized condensation, ice, dirt, or internal fogging can still obstruct the FOV independently of the wiped region.

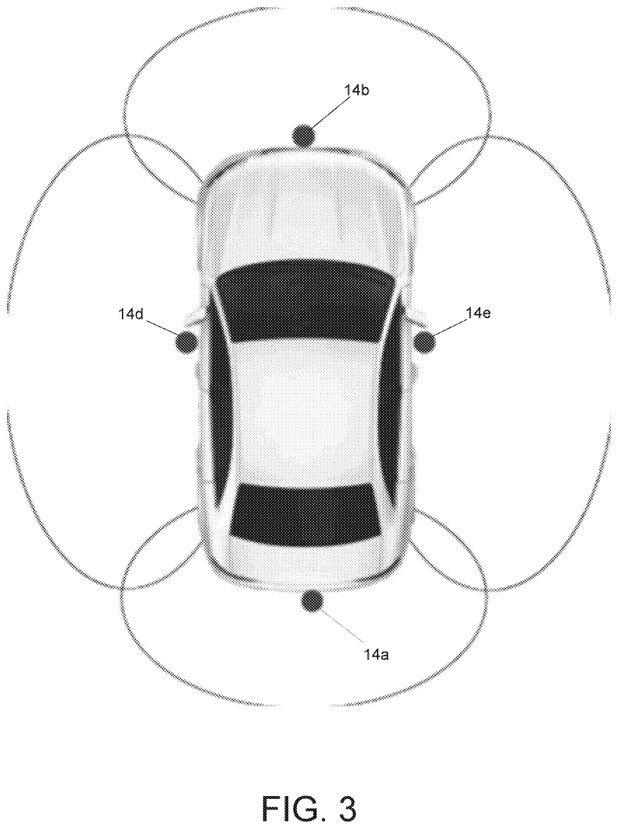

Referring to FIG. 3, as with the ADAS, a surround view system (SVS) may be part of the vehicle vision system. The SVS may include the forward viewing camera 14b at the front of the vehicle (e.g., disposed at a bumper or grille of the vehicle), sideward viewing cameras 14d, 14e at respective sides of the vehicle (e.g., disposed at the side-mirrors of the vehicle), and a rearward viewing camera 14a at the rear of the vehicle (e.g., disposed at a bumper or trunk lid of the vehicle). Collectively, the cameras 14a, 14b, 14d, 14e of the SVS provide the driver with a live video feed providing a 360-degree view of the vehicle and its surroundings. The SVS may provide the video feed on a human machine interface (HMI) of the vehicle.

The vehicular vision system may, via the HMI, provide the driver with options to select a view of a plurality of views captured by the SVS and/or the ADAS that the driver may find most suitable for driving comfort and/or based on a current driving situation. Additionally or alternatively, the vehicular vision system may display blind spot views on the HMI. For example, the system may display a blind spot view on the HMI responsive to a request from the driver, data collected by sensors of the vehicle indicating presence of an object proximate to the vehicle, steering inputs, turn signal inputs, gear selection, and/or other driving inputs performed by the driver.

To generate the 360-degree view, the SVS image processor may execute distortion correction algorithms to de-warp the wide-angle or fisheye image data, and stitch the disparate camera feeds together seamlessly, mapping the synchronized images onto a virtual two-dimensional (2D) plane or three-dimensional (3D) bowl model. The stitched composite image allows the driver to perceive the vehicle relative to parking lines, curbs, and nearby obstacles. The HMI may comprise a center-stack touchscreen display and may superimpose dynamic overlays onto the SVS video feed, such as projected trajectory lines that articulate based on a measured steering angle, and colored distance markers denoting proximity to detected obstacles.

Imaging sensors such as cameras and camera systems have a significant role in vehicular vision systems, ADASs, SVSs, and other safety systems and features of modern vehicles, especially with the increasing use of autonomous driving technology. An unobstructed field of view (FOV) of the cameras is important to proper function of these systems and features and to safe operation of the vehicle. Reliable sensor data is essential for vehicular vision systems, ADASs, SVSs, and autonomous driving systems and/or features.

Machine vision algorithms rely heavily on image clarity, contrast, and edge detection to accurately classify and track objects. When an imaging sensor is occluded, the optical signal-to-noise ratio decreases, which can cause deep learning algorithms or object detection logic to output false negatives (e.g., failing to detect a pedestrian) or false positives (e.g., phantom braking due to a localized blur artifact or occlusion). In highly automated or fully autonomous driving systems, an occlusion not only degrades a human driver's viewing experience but fundamentally compromises the operational design domain (ODD) of the autonomous driving system, potentially forcing an unexpected system disengagement or an emergency minimal risk maneuver. Thus, real-time detection and mitigation of sensor occlusion is critical for system reliability.

An automatic lens cleaning system helps maintain clear lenses for the imaging sensors and increases imaging sensor performance across various driving conditions, including rainy, snowy, and/or high dust or dirt environments. That is, the automatic lens cleaning system removes occlusions or obstructions from imaging sensors of the vehicle. Customer adoption of driver assist features (e.g., automatic lane keeping, automatic lane changes, automatic parking, etc.) and ADASs has resulted in a large increase in imaging sensors equipped on vehicles and in an increased popularity in vehicular vision systems that utilize image data captured by the sensors to perform these driving assist features. Thus, vehicular systems that utilize cameras and/or imaging sensors for safety and automation have become increasingly common in modern vehicles.

Because many of these exterior-viewing cameras are positioned in hard-to-reach locations or locations highly susceptible to road spray, such as integrated within front grilles, lower bumpers, sideview mirror housings, or rear liftgates, manual cleaning by a driver is frequently impractical or impossible during a trip. Furthermore, as vehicles progress toward higher levels of automation, such as SAE Level 3 through Level 5 autonomous driving, the continuous availability and reliability of sensor data without human intervention becomes a strict requirement. An automatic lens cleaning system ensures high system availability without requiring the driver to manually inspect and clear the exterior lenses.

Mud, snow, dust, rain, insects, and/or debris may soil, obstruct, and/or occlude lenses of the vehicular cameras, which may impact functionality of the vehicular vision system. Obstruction of a camera may risk malfunctions of the vehicular vision system, may reduce functionality of safety features of the vehicle, and/or may reduce visibility for the driver of the vehicle, increasing the likelihood of accidents. Accordingly, there is a need for a way to clean the camera lenses and/or the sensors of the vehicle. Different types of occlusions degrade optical performance in varying ways. For example, dried mineral deposits from road salt or rain droplets can act as micro-lenses, scattering incoming light and causing severe glare or blooming artifacts when exposed to oncoming headlights or low-angle sunlight. Solid, opaque occlusions like mud or snow can completely block specific regions of interest (ROI) across the CMOS imaging array, resulting in blind spots in the machine vision algorithms. Even a thin layer of dust can significantly reduce the overall contrast and edge definition of the captured image data, potentially causing false negative object detection.

The vehicle may include one or more systems for cleaning a camera lens and/or imaging sensor. A washer system may spray or otherwise apply fluid to the lens to remove loose debris. Such a washer system may utilize one or more micro-nozzles integrated into a housing of the camera, and may be fluidically coupled via routing lines and solenoid valves to a central windshield washer fluid reservoir of the vehicle or to a dedicated localized fluid reservoir. An air blast system may apply air on or across the lens to remove debris without the use of fluid. For example, the air blast system may be used in dry environments to remove particles that have collected on the lens. Optionally, the air blast system may apply warm or hot air on or across the lens to melt snow or ice from the lens when the vehicle is in a cold environment. The air blast system may utilize a dedicated micro-compressor or may route forced air from a localized heating element or the vehicle's HVAC system.

A mechanical wiper system may use a blade (e.g., a rubber blade, a squeegee, etc.) to wipe debris from the lens. The mechanical wiper may provide consistent clearing of the lens, removing contaminants, debris, or relatively large occlusions. The mechanical wiper system may comprise a miniaturized stepper motor and wiper arm packaged adjacent to the lens cover glass. An ultrasonic vibration system may use high-frequency vibrations to remove small particles (e.g., microscopic particles) from the lens. The ultrasonic vibration system may use low power to efficiently clean the lens. For example, the ultrasonic vibration system may comprise a piezoelectric transducer mechanically coupled to the camera's cover glass. Actuating the transducer at specific resonant frequencies can induce cavitation to atomize water droplets, or physically shed solid particulate from the optical surface.

In addition to, or as alternatives to, the cleaning systems described above, the physical camera cleaning system may comprise other hardware configured to physically remove contamination from the lens or a transparent cover of the camera. For example, the cleaning system may comprise a high-pressure micro-jet cleaning system configured to direct one or more high-pressure, low-volume liquid jets toward the lens or transparent cover to dislodge adhered debris. Optionally, the cleaning system may comprise a two-phase jet cleaning system configured to deliver a combined stream of liquid and gas (e.g., an air-assisted liquid jet) toward the lens or transparent cover to enhance shearing and particle detachment. To address frozen occlusions, the system may utilize a resistive heating system configured to heat the lens or transparent cover, such as via an integrated transparent conductive heating element, to melt and physically release ice, frost, or snow. For dry particulate removal, the system may comprise an electrostatic particle removal system configured to generate an electrostatic field near the lens or transparent cover to repel and lift dust or fine contaminants from the surface, or an electrodynamic screen system configured to apply time-varying electric fields via patterned electrodes to convey dust particles off the surface. Additional or alternative vibrational methods may be utilized, such as a low-frequency mechanical vibration system configured to apply non-ultrasonic mechanical vibration to the lens or transparent cover to loosen adhered contaminants, and/or a piezoelectric actuation system configured to actuate the lens or transparent cover with one or more piezoelectric actuators to induce surface deformation (e.g., a flexural mode) that breaks the adhesion of contaminants.

The ADAS, SVS, and/or vehicular vision system may include dirty lens detection (DLD). The DLD may detect obstruction, occlusion, and/or reduced visibility of one or more cameras of the vision system and notify the driver by, for example, displaying a visible notification on the instrument cluster, dashboard, infotainment system, and/or HMI of the vehicle. Additionally or alternatively, the DLD may audibly and/or haptically notify the driver of the obstruction. The DLD may utilize an image processing algorithm executing on the ECU to analyze the sequence of image frames. The image processing algorithm may detect an occlusion by measuring localized blur, analyzing temporal contrast degradation, detecting static, unchanging pixel regions over multiple frames indicative of a fixed spot on the lens, or by utilizing a convolutional neural network (CNN) trained on datasets of occluded lens imagery. The DLD may, based on current environmental conditions (e.g., the ambient temperature of the vehicle's environment, humidity, data from a precipitation sensor, etc.), determine or predict or estimate a type or class of the occlusion. For example, the DLD may determine whether debris (e.g., dirt, dust, mud, particulate, insects) or snow and/or ice has occluded a lens of the vehicle. In one example, the DLD may determine, based at least in part on the ambient temperature being below the freezing point of water, that the occlusion is snow and/or ice. In another example, the DLD may determine, based on the ambient temperature being above the freezing point of water, that the occlusion is dirt or debris other than snow and/or ice. The ECU may access these environmental conditions via data from a vehicle network bus, such as a Controller Area Network (CAN) bus, which provides real-time ambient temperature readings, wiper state data, and inputs from rain and precipitation sensors. In some examples, the DLD may prompt the driver with a notification indicating that the DLD has determined the cause of the occlusion. For example, the DLD may provide a notification that indicates that either debris or snow and/or ice has occluded the affected lens. Optionally, where the vehicle is equipped with more than one camera, the DLD may indicate which of the one or more cameras is occluded. The notification may include a visual icon on the HMI corresponding to the specific affected camera, such as a highlighted sector in a top-down SVS display.

The DLD may receive input from the driver, such as via the HMI and/or an audible command, to clear the occluded lens. Responsive to receiving the input from the driver to clear the occluded lens, the DLD may enable the appropriate cleaning system based on the type of occlusion. For example, the DLD may activate or enable or actuate the washer system (e.g., for mud) and/or the air blast system (e.g., for snow/ice). In other examples, the DLD may automatically clear the occluded lens responsive to detecting an occlusion or obstruction. Optionally, the driver may select from one or more cleaning systems with which to clean the lens. In an automated configuration, the DLD may initiate a sequential cleaning routine. For example, if a first application of washer fluid fails to clear the lens, the DLD may automatically trigger a secondary, longer pulse of washer fluid, or actuate a combination of systems, such as spraying fluid followed by an air blast to dry the lens. During operation of the lens cleaning system, the DLD may continuously monitor, via processing image data collected by the affected camera, the FOV of the lens to determine whether the occlusion and/or obstruction has been removed from the lens such that the vehicular vision system, ADAS, and/or SVS may continue to normal operation. This continuous monitoring creates a closed-loop feedback mechanism ensuring the lens is sufficiently cleared before resuming machine vision functions. Responsive to determining that the occlusion and/or obstruction has been removed, the DLD may deactivate the notification so as to indicate to the driver that the occlusion and/or obstruction has been removed. If the DLD determines that the occlusion persists after a threshold number of automated cleaning attempts, the ECU may generate a diagnostic trouble code (DTC) and issue a persistent notification to the driver recommending manual inspection and cleaning of the affected camera, and may safely disable or degrade the functionality of the dependent ADAS features until the lens is manually cleared.

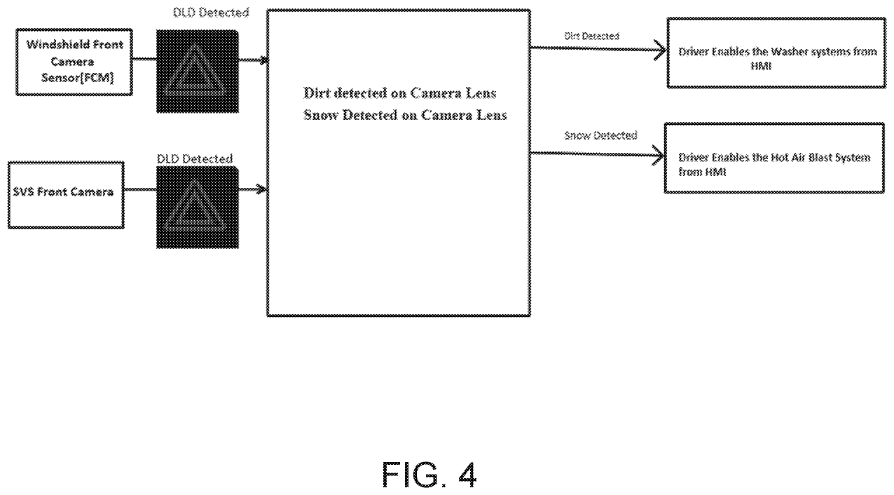

FIG. 4 illustrates a block diagram of an example DLD. As illustrated in FIG. 4, the DLD utilizes a logical flow that processes inputs from the respective cameras to classify the operational state of the lenses. The DLD may monitor an FCM imaging sensor at a windshield of a vehicle. The DLD may also monitor an SVS front camera, such as a camera mounted at the front of the vehicle. Optionally, the DLD may monitor any imaging sensor equipped at the vehicle. Responsive to determining an occlusion or obstruction of either the FCM sensor or the SVS camera, the DLD may notify a driver of the vehicle at an HMI, an instrument cluster, a dashboard, and/or an infotainment system of the vehicle. The notification may be visual, audible, and/or haptic. The DLD may determine, based on a current environmental condition (e.g., an ambient temperature of the environment surrounding the vehicle), a type of occlusion. For example, the DLD may determine whether debris or snow has occluded the affected imaging sensor based on the ambient temperature exterior of the vehicle. The determination of the current environmental condition may further incorporate data from rain sensors, windshield wiper activation states, or localized weather data retrieved via a vehicle telematics unit. By correlating the detected occlusion with an ambient temperature below a predetermined threshold (e.g., zero degrees Celsius or 32 degrees Fahrenheit), the ECU can infer with high confidence that the occlusion comprises frozen precipitation, such as snow or ice, rather than liquid mud or dry dust.

Responsive to determining that debris has occluded the affected imaging sensor, the DLD may actuate a washer system to spray fluid on the lens to remove the debris from the lens. For example, the ECU may transmit a control signal to a fluid pump to deliver pressurized washer fluid through a nozzle directed at the lens. The spray may be delivered as a continuous stream or as a series of high-pressure pulses to dislodge stubborn particulates. The selection of the washer system for debris such as mud or dust leverages the solvent properties of the washer fluid to dissolve and carry away the particulate matter without risking scratching the lens surface, which could otherwise occur if a dry mechanical wiper were utilized on dry, abrasive dirt. Optionally, the DLD may actuate the washer system responsive to input from the driver to enable the washer system. Additionally or alternatively, the DLD may use a mechanical wiper or ultrasonic vibration to remove the debris from the lens.

Responsive to determining that snow and/or ice has occluded the affected imaging sensor, the DLD may actuate an air blast system to pass warm/hot air across the lens to remove the snow and/or ice from the lens. Actuating a hot air blast advantageously melts the frozen occlusion without introducing additional liquid fluid that might immediately freeze upon contact with the cold lens. The ECU may control a localized heating element in combination with a pneumatic compressor to generate the hot air blast, optionally pulsing the air or varying the air temperature and velocity to optimize melting while conserving vehicle electrical power. Optionally, the DLD may actuate the air blast system responsive to input from the driver to enable the air blast system. Additionally or alternatively, the DLD may use a mechanical wiper or ultrasonic vibration to remove the snow and/or ice from the lens. In some implementations, the hot air blast may be used sequentially with an ultrasonic vibration system to quickly shed the liquid water droplets remaining after the snow or ice has been melted.

During actuation of the air blast system and/or the washer system, the DLD may monitor image data of the affected camera to determine if the obstruction has been removed. This dynamic monitoring provides a closed-loop control system. The DLD may evaluate a recovery metric, such as an average pixel contrast ratio, an edge-detection sharpness gradient, or a machine vision confidence score, and compare the recovery metric against a predefined baseline threshold. Responsive to determining that the obstruction has been removed, the DLD may cease actuation of the air blast system and/or the washer system and remove the notification from the HMI. Terminating the cleaning cycle once the recovery metric exceeds the baseline threshold ensures the optical pathway is sufficiently clear for reliable machine vision operation while preventing unnecessary depletion of washer fluid or excessive power draw from the air blast system.

An unobstructed and unoccluded field of view FOV of cameras of a vehicle is important to proper function of vehicular vision systems, ADASs, SVSs, autonomous driving systems and features of modern vehicles. An unobstructed and unoccluded FOV further increases the comfort and safety of the driver and/or occupants of the vehicle by helping the driver identify objects proximate to the vehicle. Mud, snow, rain, insects, and/or debris may soil, obstruct, and/or occlude lenses of the vehicular cameras, which may impact functionality of the vehicular vision system. A DLD cleans lenses of the imaging sensors and increases imaging sensor performance across various driving conditions, including rain, snow, debris, and/or high dust or dirt environments. The DLD may, by processing image data from one or more cameras (e.g., by using one or more image processing algorithms), detect obstruction, occlusion, and/or reduced visibility of one or more cameras of the vision system and notify the driver by displaying a visible notification on the instrument cluster, dashboard, infotainment system, and/or HMI of the vehicle. The DLD may determine, based at least on an ambient temperature of the environment surrounding the vehicle, whether debris or snow has occluded the affected imaging sensor. Either automatically or in response to input from the driver, the DLD may use one or more systems equipped at the vehicle for cleaning a camera lens and/or imaging sensor, such as a washer system, an air blast system, a mechanical wiper system, and/or an ultrasonic vibration system. The DLD may select from the cleaning systems based on whether the obstruction is determined to be debris or snow and/or ice. By intelligently categorizing the obstruction and deploying a targeted cleaning countermeasure, the vehicular vision system maximizes both cleaning efficacy and resource efficiency.

The lens cleaning systems may comprise a variety of systems that function to clear moisture or snow or ice or dirt or insects or debris from the lens. For example, the lens cleaning systems may utilize aspects of the systems and devices described in U.S. Pat. Nos. 11,889,171; 11,140,301; 10,894,275; 10,604,121; 10,399,509; 9,707,896 and/or 7,965,336, and/or U.S. Publication Nos. US-2024-0147036; US-2018-0361998 and/or US-2016-0272163, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The ECU may be operable to process data for at least one driving assist system of the vehicle. For example, the ECU may be operable to process data (such as image data captured by a forward-viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0245662; US-2021-0162926; US-2021-0155167 and/or US-2019-0118717, which are all hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Optionally, the vision system (utilizing the forward-viewing camera and a rearward-viewing camera and other cameras disposed at the vehicle with exterior fields of view) may be part of or may provide a display of a top-down view or bird's-eye view system of the vehicle or a surround view at the vehicle, such as by utilizing aspects of the vision systems described in U.S. Pat. Nos. 10,071,687; 9,900,522; 9,834,153; 9,762,880; 9,596,387; 9,264,672; 9,126,525 and/or 9,041,806, and/or U.S. Publication No. US-2015-0022664, which are hereby incorporated herein by reference in their entireties.

Optionally, the display may be viewable through a reflective element of a mirror assembly when the display is activated to display information. Optionally, the display element may comprise any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like.

The display device may be disposed at or incorporated in an interior mirror assembly, and the interior mirror assembly may comprise a dual-mode interior rearview video mirror that can switch from a traditional reflection mode to a live-video display mode, such as by utilizing aspects of the mirror assemblies and systems described in U.S. Pat. Nos. 10,442,360; 10,421,404; 10,166,924 and/or 10,046,706, and/or U.S. Publication Nos. US-2021-0323473; US-2021-0245662; US-2021-0162926; US-2021-0155167; US-2021-0094473; US-2020-0377022; US-2019-0258131; US-2019-0146297; US-2019-0118717; US-2019-0047475 and/or US-2017-0355312, which are all hereby incorporated herein by reference in their entireties. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742 and/or 6,124,886, and/or U.S. Publication No. US-2006-0050018, which are hereby incorporated herein by reference in their entireties.

Changes and modifications in the specifically described embodiments can be carried out without departing from the principles of the disclosure, which is intended to be limited only by the scope of the appended claims, as interpreted according to the principles of patent law including the doctrine of equivalents.

1. A vehicular vision system, the vehicular vision system comprising:
a camera disposed at a vehicle equipped with the vehicular vision system and viewing exterior of the vehicle, the camera capturing image data;
wherein the camera comprises an imager;
an electronic control unit (ECU) comprising electronic circuitry and associated software;
wherein the electronic circuitry of the ECU comprises an image processor for processing image data captured by the camera to detect presence of objects in a field of view of the camera;
wherein the ECU determines, responsive to processing by the image processor of the image data captured by the camera, that the field of view of the camera is occluded;
wherein the vehicular vision system determines a type of occlusion based at least in part on a current environmental condition;
wherein the vehicular vision system selects a physical camera cleaning system from a plurality of physical camera cleaning systems based on the determined type of occlusion, and wherein each physical camera cleaning system of the plurality of physical camera cleaning systems is configured to physically remove the occlusion from a lens or a transparent cover of the camera;
wherein the vehicular vision system displays a notification to a driver of the vehicle indicating that the camera is occluded; and
wherein the vehicular vision system enables the selected physical camera cleaning system.

2. The vehicular vision system of claim 1, wherein the vehicular vision system, responsive to processing by the image processor of image data captured by the camera, (i) determines that the field of view of the camera is no longer occluded and (ii) deactivates the selected physical camera cleaning system.

3. The vehicular vision system of claim 1, wherein the selected physical camera cleaning system comprises at least one selected from the group consisting of (i) a washer system, (ii) an air blast system, (iii) a mechanical wiper system and (iv) an ultrasonic vibration system.

4. The vehicular vision system of claim 1, wherein the selected physical camera cleaning system comprises a washer system.

5. The vehicular vision system of claim 1, wherein the selected physical camera cleaning system comprises a hot air blast system.

6. The vehicular vision system of claim 1, wherein the notification comprises at least one selected from the group consisting of (i) a visual notification, (ii) an audible notification and (iii) a haptic notification.

7. The vehicular vision system of claim 1, wherein the notification indicates the determined type of occlusion that is occluding the camera.

8. The vehicular vision system of claim 1, wherein the determined type of occlusion comprises at least one selected from the group consisting of (i) dirt and (ii) snow.

9. The vehicular vision system of claim 1, wherein the vehicular vision system comprises a plurality of cameras including the camera, and wherein the notification identifies a respective one or more cameras of the plurality of cameras that are occluded.

10. The vehicular vision system of claim 1, wherein the current environmental condition comprises an ambient temperature exterior of the vehicle.

11. The vehicular vision system of claim 1, wherein the determined type of occlusion is ice or snow.

12. The vehicular vision system of claim 1, wherein the determined type of occlusion is not ice or snow.

13. The vehicular vision system of claim 1, wherein the vehicular vision system enables the selected physical camera cleaning system responsive to receiving an input from an occupant of the vehicle.

14. The vehicular vision system of claim 1, wherein the vehicular vision system automatically enables the selected physical camera cleaning system responsive to determining that the field of view of the camera is occluded.

15. A method for operating a vehicular vision system, the method comprising:
capturing image data by a camera disposed at a vehicle equipped with the vehicular vision system and viewing exterior of the vehicle, wherein the camera comprises an imager;
processing, by an image processor of an electronic control unit (ECU), the image data captured by the camera to detect presence of objects in a field of view of the camera;
determining, by the ECU responsive to processing by the image processor of the image data captured by the camera, that the field of view of the camera is occluded;
determining a type of occlusion based at least in part on a current environmental condition;
selecting a physical camera cleaning system from a plurality of physical camera cleaning systems based on the determined type of occlusion, wherein each physical camera cleaning system of the plurality of physical camera cleaning systems is configured to physically remove the occlusion from a lens or a transparent cover of the camera;
displaying a notification to a driver of the vehicle indicating that the camera is occluded; and
enabling the selected physical camera cleaning system.

16. The method of claim 15, further comprising:
determining, responsive to processing by the image processor of image data captured by the camera, that the field of view of the camera is no longer occluded; and
deactivating the selected physical camera cleaning system.

17. The method of claim 15, wherein the selected physical camera cleaning system comprises at least one selected from the group consisting of (i) a washer system, (ii) an air blast system, (iii) a mechanical wiper system and (iv) an ultrasonic vibration system.

18. The method of claim 15, wherein the selected physical camera cleaning system comprises a washer system.

19. The method of claim 15, wherein the selected physical camera cleaning system comprises a hot air blast system.

20. The method of claim 15, wherein the notification comprises at least one selected from the group consisting of (i) a visual notification, (ii) an audible notification and (iii) a haptic notification.
